(19) United States
(12) Patent Application Publication
(10) Pub. No.: US 2016/0084658 A1
(43) Pub. Date: Mar. 24, 2016

(54) METHOD AND APPARATUS FOR TRAJECTORY CROWD SOURCING FOR UPDATING MAP PORTAL INFORMATION

(71) Applicant: QUALCOMM Incorporated, San Diego, CA (US)

(72) Inventors: Hui CHAO, San Jose, CA (US); Yin CHEN, Campbell, CA (US); Sameera PODURI, Santa Clara, CA (US); Saumitra M. DAS, Santa Clara, CA (US)

(21) Appl. No.: 14/495,442

(22) Filed: Sep. 24, 2014

(51) Int. Cl. G01C 21/20; G01C 21/00

(52) U.S. Cl. CPC G01C 21/206; G01C 21/00

(57) ABSTRACT

A method for updating a digital map includes receiving a digital map that shows a first region and a second region, and where the digital map includes a border that separates the first region from the second region. The method also includes receiving user trajectory data and generating portal information based on the received user trajectory data that cross the border between the first and second regions. The digital map is then updated with the portal information.

### TECHNICAL FIELD

This disclosure relates generally to digital maps, and in particular but not exclusively, relates to digital maps for use in navigation.

### BACKGROUND INFORMATION

Navigation systems are becoming more and more pervasive in today's market. A navigation system may be utilized to determine a route from a first location to a destination. In some navigation systems, a user may enter a start location and a destination into a mapping application, such as one of the different mapping applications commonly used on a variety of websites.

The Global Positioning System (GPS) represents one type of navigation system, which along with other types of satellite positioning systems (SPS) provide or otherwise support signal-based position location capabilities (e.g., navigation functions) in mobile stations, and particularly in outdoor environments. However, since some satellite signals may not be reliably received and/or acquired by a mobile station within an indoor environment, different techniques may be employed to enable position location services.

For example, mobile stations may attempt to obtain a position fix by measuring ranges to three or more terrestrial transmitters (e.g., wireless access points, beacons, cell towers, etc.) which are positioned at known locations. Such ranges may be measured, for example, by obtaining range measurements to the transmitters by measuring one or more characteristics of signals received from such transmitters such as, for example, signal strength, a round trip delay time, etc.

These and other position location and navigation techniques tend to be of further benefit to a user if presented with certain mapped features. For example, mapped features may relate to or otherwise identify certain physical objects, characteristics, or points of interest within a building or complex, etc. Thus, in certain instances, an indoor navigation system may provide a digital map to a mobile station upon entering a particular indoor area, e.g., in response to a request for position assistance data. Such a map may show indoor features such as doors, hallways, entry ways, walls, etc., points of interest such as bathrooms, pay phones, room names, stores, etc. Such a digital map may be stored at a server to be accessible by a mobile station through selection of a URL, for example.

However, in some cases, detailed structural information or functional information included in the map stored at the server may be limited. For example, the stored digital map may lack information regarding the entrance of a venue and/or the location and size of the doors to or within the structure. Furthermore, the digital map may lack information about the location or even the existence of pedestrian walk ways that may connect outdoor to indoor locations.

In other cases, the map may include map data that was automatically extracted from an image file. However, some of the automatically extracted information, such as a building boundary, may be imprecise. Even still, the stored digital map may become outdated as the building structure is changed (e.g., a store may change its entrance and exit pathways).

### BRIEF SUMMARY

According to one aspect of the present disclosure, a method for updating a digital map includes receiving a digital map that shows a first region and a second region, and where the digital map includes a border that separates the first region from the second region. The method also includes receiving user trajectory data and generating portal information based on the received user trajectory data that cross the border between the first and second regions. The method then includes updating the digital map with the portal information.

According to another aspect of the present disclosure, a computer-readable medium includes program code stored thereon for updating a digital map. The program code includes instructions to receive the digital map, where the digital map shows a first region and a second region, where the digital map includes a border that separates the first region from the second region. The program code further includes instructions to receive user trajectory data and to generate portal information based on the received user trajectory data that cross the border between the first and second regions. The digital map is then updated with the portal information.

In a further aspect of the present disclosure, an apparatus, such as a map server, includes memory adapted to store program code for updating a digital map and a processing unit configured to access and execute instructions included in the program code. When the instructions are executed by the processing unit, the processing unit directs the map server to receive a digital map, where the digital map shows a first region and a second region, and where the digital map includes a border that separates the first region from the second region. The processing unit directs the apparatus to receive user trajectory data and to generate portal information based on the received user trajectory data that cross the border between the first and second regions. The digital map is then updated with the portal information.

The above and other aspects, objects, and features of the present disclosure will become apparent from the following description of various embodiments, given in conjunction with the accompanying drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a functional block diagram of a navigation system.

FIG. 2 is a functional block diagram of a map system.

FIG. 3 illustrates a process of updating a digital map based on collected trajectory data.

FIG. 4 illustrates a process of identifying a portal on a digital map based on collected trajectory data.

FIG. 5 is an example digital map showing trajectory data crossing a border between regions of the map.

FIG. 6 illustrates a distribution of crossing trajectories across a single wall line.

FIG. 7 is another example digital map showing trajectory data used to determine a passage or pathway between two buildings.

FIG. 8 illustrates an example user interface for displaying a digital map and for notifying a user of an improperly marked indoor region.

FIG. 9 illustrates a process of identifying an improperly marked indoor region of a digital map.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

Aspects of the present disclosure include a process of improving stored map data using collected user trajectory data. The trajectory data may be data collected from multiple mobile devices that include paths taken by the mobile device. For example, the trajectory data collected from each mobile device may include a time-ordered set of location points that the mobile device has traveled. In one embodiment, a portal (e.g., accessor, door, entrance, exit, ingress, egress, pathway, walkway, passage, escalator, etc.) may be determined from the collected trajectory data. In another embodiment, the server may provide a feedback warning to an operator to identify imprecise stored map data, also based on the received trajectory data.

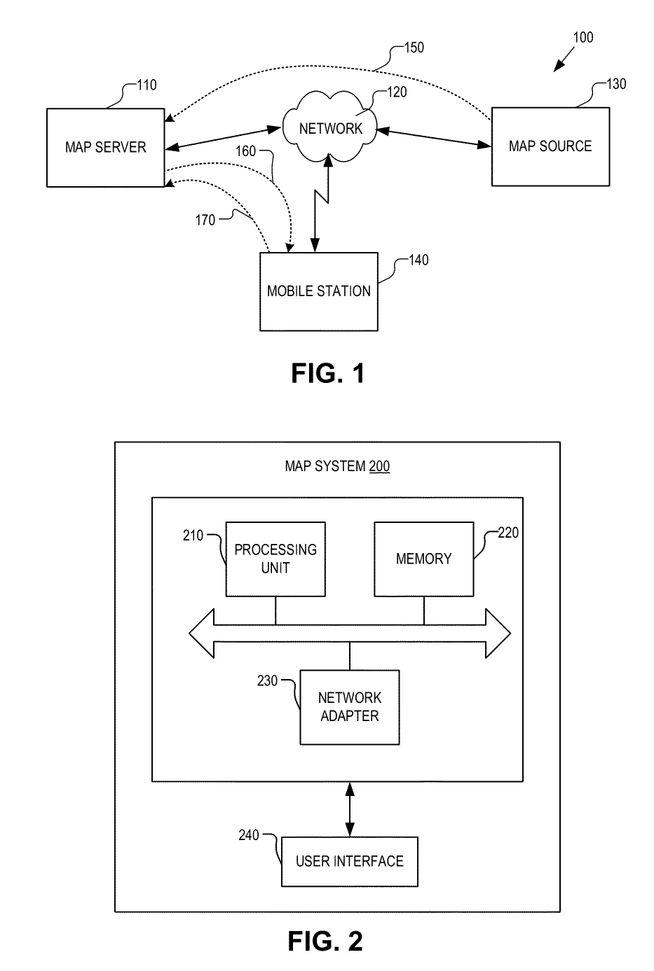

FIG. 1 is a functional block diagram of an example navigation system 100. As shown, navigation system 100 may include a map server 110, a network 120, a map source 130, and a mobile station 140. Map source 130 may comprise a memory and may store digital maps that may or may not contain any annotations or other information indicating locations of entryways or hallways/corridors, for example. In one embodiment, map source 130 may store the digital maps in raster format or in vector format. The stored digital maps may include drawings of line segments which may indicate various interior features of a building structure, such as a border that separates an indoor region from an outdoor region or a border that separates one indoor region from another indoor region.

In one implementation, map source 130 may create digital maps by scanning paper blueprints of a building into an electronic format that does not include any annotations. Alternatively, map source 130 may acquire digital maps from an architectural firm that designed a building or from public records, for example.

Digital maps 150 may be transmitted by map source 130 to map server 110 via network 120. However, in other embodiments map source 130 may directly transmit the digital maps 150 to map sever 110 without utilizing network 120. Map source 130 may comprise a database or server, for example. In one implementation, map server 110 may transmit a request for a particular basic digital map to map source 130 and in response the particular digital map may be transmitted to map server 110. As mentioned above, one or more maps in map source 130 may be scanned from blueprints or other documents.

Map server 110 may provide a user interface for a user to identify one or more features of the digital map, such as entryways, hallways, or other items on the digital map. In response to user input, the map is tagged to identify various regions of the digital map as corresponding with a known feature (e.g., wall, building boundary, entryway, etc.). In another embodiment, a region in the map is identified as a particular feature only when multiple mobile stations have similarly tagged it at such. In another embodiment, if the user has a high probability of others similarly tagging regions then based on this trust probability the region may be tagged.

The tagged digital map may subsequently be utilized by navigation system 100 to generate various position assistance data that may be used to provide routing directions or instructions to guide a person from a starting location depicted on a map to a destination location in an office, shopping mall, stadium, or other indoor environment. As discussed above, a person may be guided through one or more hallways to reach a destination location. Digital maps and/or routing directions 160 may be transmitted to a user's mobile station 140 either directly or through network 120. For example, such digital maps and/or routing directions may be presented on a display screen of mobile station 140. Routing directions may also be audibly presented to a user via a speaker of mobile station 140 or in communication with mobile station 140. Map server 110, map source 130 and mobile station 140 may be separate devices or combined in various combinations (e.g., all combined into mobile station 140; map source 130 combined into map 110, etc.).

Furthermore, mobile station 140, as well as other mobile devices (not shown) may provide trajectory data 170 to map server 110. As mentioned above, trajectory data 170 may include a time-ordered set of location points that mobile station 140 has traveled. Using the received trajectory data 170, as well as trajectory data received from other mobile devices, map server 110 may update the map data associated with digital map 150.

FIG. 2 is a functional block diagram of a map system 200. Map system 200 is one possible implementation of map server 110 and/or mobile station 140 of FIG. 1. Map server 200 may include a processing unit 210, memory 220, and a network adapter 230. Memory 220 may be adapted to store computer-readable instructions, which are executable to perform one or more of processes, implementations, or examples thereof which are described herein. Processing unit 210 is coupled (directly or indirectly) to memory 220 and is configured to access and execute such machine-readable instructions. Through execution of these computer-readable instructions, processing unit 210 may direct various elements of map server 200 to perform one or more functions.

As mentioned above, map system 200 may be one implementation of a map server, but in other embodiments, system 200 may be a mobile station, wireless device, cell phone, personal digital assistant, mobile computer, tablet, personal computer, laptop computer, wearable computer, or any other type of device that has processing capabilities.

Map system 200 is shown as further including a user interface 240 that includes a means for displaying the images, such as a display. The user interface 240 may also include a keyboard or other input device through which user input (data) can be input into the map system 200. If desired, the keyboard may be obviated by integrating a virtual keypad into the display with a touch sensor.

In operation, network adapter 230 may receive one or more digital maps for analysis from a digital map source. Memory 220 may store the received digital map and trajectory data of multiple mobile stations, also received via network adapter 230. After receiving the trajectory data, map system 200 may analyze the trajectory data in order to refine and update the stored digital map with portal information.

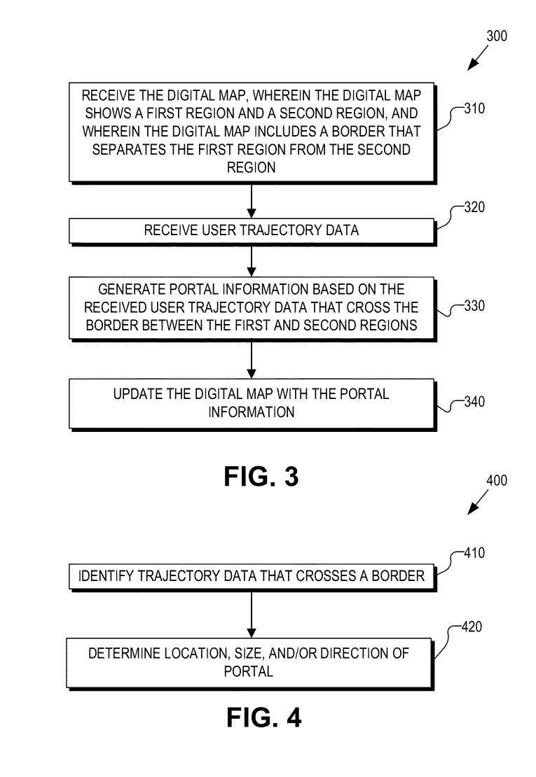

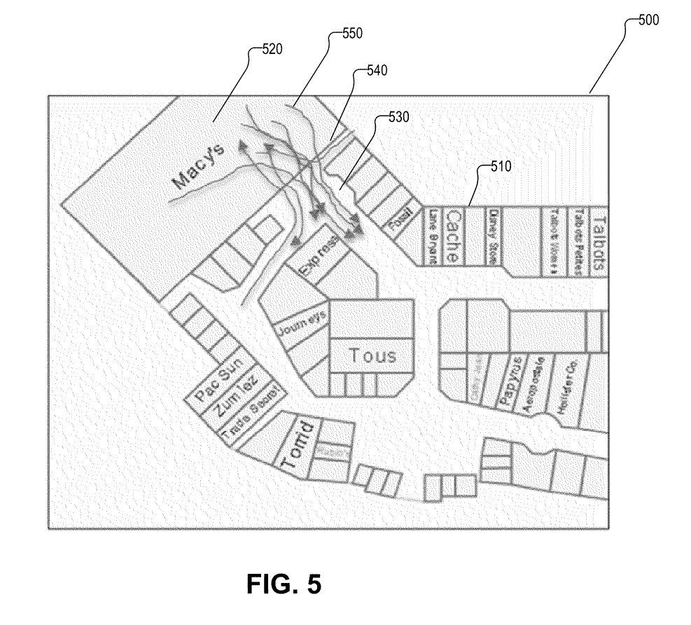

FIG. 3 illustrates a process 300 of updating a digital map based on collected trajectory data. Process 300 is one possible process for updating digital map data implemented by map server 110 of FIG. 1 and/or map system 200 of FIG. 2. Process 300 may begin at process block 310 which includes receiving a digital map. By way of example, FIG. 1 illustrates map server 110 receiving digital map 150 from map source 130. As mentioned above, the digital map may include drawings of line segments, which may indicate various interior features of a building structure, such as a border that separates an indoor region from an outdoor region or a border that separates one indoor region from another indoor region. For example, FIG. 5 illustrates an example digital map 500. As shown, digital map is a drawing that shows several indoor features of a building 510 (i.e., a shopping mall), including the boundaries of several interior venues (i.e., stores). By way of example, digital map 500 includes a line segment 540 that represents a border that separates a first indoor region 520 (interior to MACY'S® venue) from a second indoor region 530 (exterior to the MACY'S® venue but still interior to building 510).

Returning now to FIG. 3, process 300 then proceeds to process block 320 where user trajectory data is received. As shown in the example of FIG. 1, user trajectory data 170 may be received by map server 110 from one or more mobile stations 140 via network 120. As mentioned above, the trajectory data collected from each mobile device may include a time-ordered set of location points that the mobile station has traveled. In one embodiment, trajectory data may be stored in local memory on the mobile station and later sent to the map server (e.g., when the mobile station has established network connectivity (e.g., Wifi) and/or been connected to a power source (e.g. plugged in)). If memory within the mobile station is, or becomes limited, the mobile station may manage trajectory data in several different ways. In one example, the mobile station may remove (delete) trajectory data that do not have a length that meets a minimum length threshold (e.g., remove trajectory data that have a length of less than 10 feet). In one aspect trajectory data may be taken from the continual movement (e.g., walking) of a pedestrian without interruptions. A interruption may be defined as a threshold amount of time (e.g., 15 minutes) that the user engages in non-walking activities such as sitting, driving, etc.

Another way that the mobile station may manage trajectory data is by reducing the granularity of the trajectories. For example, instead of recording a location every second, it can be record a location for every 2 seconds. In another embodiment, a map server may also set one or more place of interest (POI) around which trajectories are more desirable. In this example, only those trajectories that exist around a POI may be stored in memory, or alternatively, all trajectories may be stored in memory where non-POI trajectories are removed from memory first should the allocated memory reach capacity. In one embodiment, the minimum length threshold, the interruption time threshold, the granularity, and POIs may be dynamically determined based on the mobile stations capability and/or the user's history profile (e.g., how much walking the use usually does.).

Next, in process block 330, portal information is generated based on the received user trajectory data that cross the border between the first and second regions. In one example, generating the portal information may include identifying the location, size, and/or direction of a portal. In another example, generating the portal information may include identifying or alerting an operator of the map server that a region in the digital map has been improperly marked as an indoor region. Further details of generating portal information will be described in detail below. After generating the portal information, process 300 proceeds to process block 340, where the digital map is updated with the portal information. Updating the digital map may include altering the digital map, by adding, removing, relocating, resizing one or more line segments included in the digital map. In one embodiment, updating the digital map may include modifying the metadata associated with the digital map. In yet another example, updating the digital map may include alerting an operator of the map server that a region in the digital map has been improperly marked as an indoor region.

FIG. 4 illustrates a process 400 of identifying a portal on a digital map based on collected trajectory data. Process 400 is one possible implementation of process block 330 of FIG. 3. In process block 410, trajectory data that crosses a border between two regions of the digital map are identified. In one example, the digital map is overlaid with the collected trajectory data in order to determine which of the trajectory data cross the border. For example, FIG. 5 illustrates several trajectories 550 overlaid on digital map 500. As shown, each of the trajectories 550 cross border 540 (e.g., a line segment) that separates the first indoor region 520 from the second indoor region 530. In one embodiment, trajectory data is analyzed only with respect to hallway facing walls represented by hallway facing line segments in the digital map.

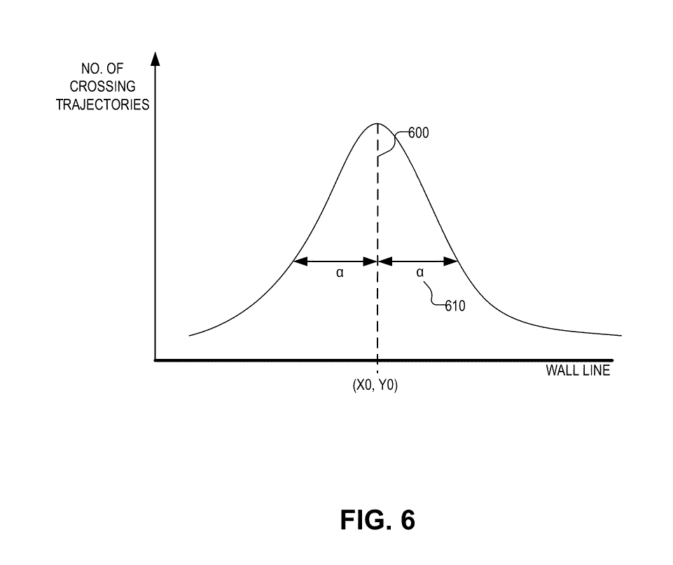

Returning now to FIG. 4, process block 420 includes determining a location, size, and/or direction of a portal between the first and second regions (e.g., entrance or exit to MACY'S®) based on the collected trajectories. FIG. 6 illustrates a distribution of crossing trajectories with respect to a particular wall line (i.e., a border). In one example, the location of the portal may be determined based on the centroid 600 of the distribution of these crossing trajectories. Thus, in the example of FIG. 6, the location of the identified portal may be determined by the X0, Y0 coordinates of centroid 600.

In another example, the size of the portal may be determined based on the standard deviation a 610 of the distribution. Thus, in the example of FIG. 6, the estimated portal size (e.g., door width) may be two times a (i.e., 2×α). In one embodiment, if the determined width is too large (e.g., width exceeds a certain percentage of a length of the line segment) then the line segment may be identified as an improperly marked border. For example, if there are trajectories that often cross a large area of a certain border then the digital map may be updated, by either indicating that the border is an improperly marked border, or by alerting an operator of the system (e.g., operator of the map server) to verify the validity of that particular border.

In yet another example, the direction (e.g., entrance or exit) may be determined based on a percentage of the trajectories having the same direction. For example, if the number of trajectories 550 that cross border 540 from the second indoor region 530 to the first indoor region 520 exceeds a first percentage threshold (e.g., 80-90%), then the portal is identified as an entrance with respect to indoor region 520. If however, if the number of trajectories 550 that cross border 540 from the first indoor region 520 to the second indoor region 530 exceeds a second percentage (e.g., 80-90%), then the portal is identified as an exit with respect to indoor region 520. In the particular example of FIG. 5, the trajectory data 550 includes trajectories of both directions, with neither direction exceeding the threshold percentages. Thus, the portal identified in FIG. 5 may be determined to be a bi-directional portal.

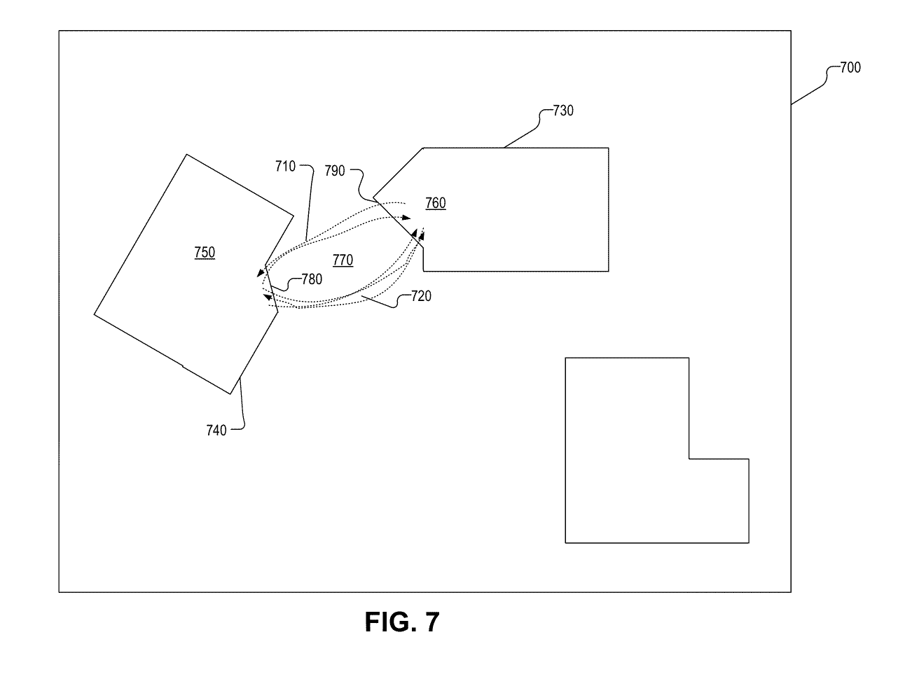

FIG. 7 is another example digital map 700 showing trajectory data 710 and 720 used to determine a portal, such as a passage or pathway between two buildings 730 and 740. Thus, in one aspect, a passage or pathway may be referred to as a portal between two buildings. As shown in FIG. 7, the trajectories 710 and 720 include paths that traverse over at least two borders separating three regions. That is, the trajectories may originate in a first indoor region 750, cross border (i.e., line segment) 780, traverse outdoor region 770, and then cross border 790 to enter into a second indoor region 760. Similarly, the trajectories may originate in the second indoor region 760, cross border 790 to outdoor region 770, and then cross border 780 into the first indoor region 750. Accordingly, embodiments of the present disclosure may further include identifying which of the received trajectories cross at least two borders separating three regions and in response, updating the digital map with the location, size, and/or direction of the passage or pathway. Similar to the example discussed above, the direction of the passage or pathway may be determined if a number of the trajectories 710 and 720 heading in the same direction exceed a threshold percentage of the total trajectories.

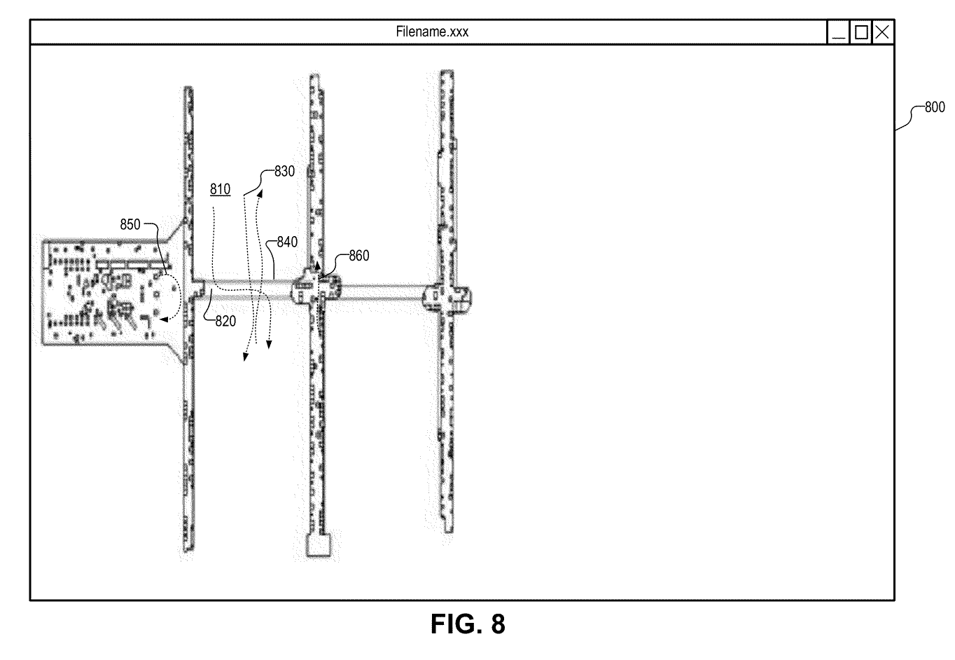

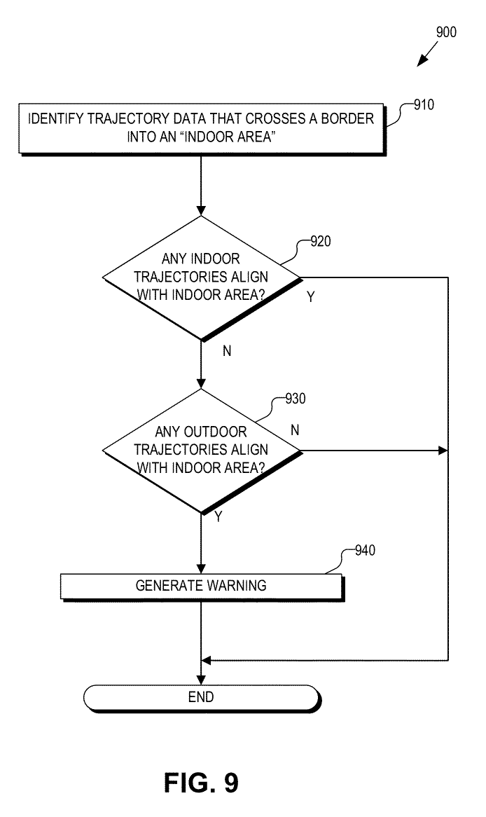

FIG. 8 illustrates an example user interface 800 for displaying a digital map and for notifying a user of an improperly marked indoor region. As mentioned above, map boundaries may be automatically extracted from an image file. However, the results can sometimes be imprecise. In the example of FIG. 8, region 820 has been improperly marked as an indoor region connecting two buildings. A process of identifying this region 820 as an improperly marked indoor region is described with reference to process 900 of FIG. 9. Process 900 is one possible implementation of process blocks 330 and 340 of process 300. In process block 910 trajectories that cross a border into an indoor area are identified. Thus, trajectories 830 are identified as they cross a border 840 from outdoor region 810 into indoor region 820.

Next, in decision block 920 it is determined whether any known indoor trajectories align with the indoor area currently being examined. For example, in FIG. 8 there exists indoor trajectories 850 and 860, and outdoor trajectories 830. In one aspect, a trajectory may be identified as an indoor trajectory if it originated, moved through, and then ended in an indoor area with respect to the designated regions on the digital map. Similarly, a trajectory may be identified as an outdoor trajectory if it originated, moved through, and then ended in an outdoor area. Additional indications of an indoor trajectory may be that the trajectory or positions along the trajectory are acquired using indoor positioning techniques, such as Wi-Fi based localization with an Inertial Measurement Unit (IMU), where a GPS signal along the trajectory is poor/weak, or where positioning error is high. On the other hand, an outdoor trajectory may be identified as such, if that trajectory started, moved through, ended in an outdoor region and is also acquired using an outdoor localization technique, such as GPS.

Returning now to decision block 920, trajectories 850 and 860 are identified as indoor trajectories, but neither of them align with indoor area 820. If a first threshold number (e.g., one) of the indoor trajectories align with the indoor area being examined, then the indoor area is likely a valid indoor area and process 900 ends. If however, it is determined that no indoor trajectories align with the indoor area, as in FIG. 8, then process 900 proceeds to decision block 930 where it is determined whether at least a second threshold number (e.g., one) of outdoor trajectories align with the indoor area. As shown in FIG. 8, each of the identified outdoor trajectories 830 align with indoor area 820. Thus, process 900 proceeds to process block 940, where a warning is generated to alert an operator of the map server that indoor area 820 may be improperly marked as an indoor area. In one example, user interface 800 may display a warning highlighting area 820, border 840, and trajectories 830 to indicate to an operator that modification of the map data identifying this region may be warranted. In another embodiment, the map may be automatically altered if it is determined that a previously marked indoor area is indeed improperly marked. For example, in one embodiment, if at least a threshold number of outdoor trajectories align with the indoor area and no indoor trajectories align with the indoor area then the border 840 may be automatically removed.

In one embodiment, the received trajectories used to locate, identify, size, and characterize a portal, passage way, pathway, and/or identify an improperly marked indoor region may be weighted based on the age of the trajectory data. That is, recent data may be weighted more heavily that older trajectory data to account for changes or modifications to building structures. For example, older trajectory data may indicate that a particular portal is an entrance (e.g., entrance to a store). However, the building may be remodeled or reconfigured such that the portal is now an exit, or even has been moved to another location within the building. In this case, newly acquired trajectory data may be weighted more heavily that the older trajectory data so as to accurately identify the portal as it is currently being used.

The order in which some or all of the process blocks appear in each process should not be deemed limiting. Rather, one of ordinary skill in the art having the benefit of the present disclosure will understand that some of the process blocks may be executed in a variety of orders not illustrated.

The teachings herein may be incorporated into (e.g., implemented within or performed by) a variety of apparatuses (e.g., devices). For example, one or more aspects taught herein may be incorporated into a mobile station, phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, a wearable computer, smart watch, or any other suitable device. These devices may have different power and data requirements and may result in different power profiles generated for each feature or set of features.

As used herein, a mobile station (MS) refers to a device such as a cellular or other wireless communication device, personal communication system (PCS) device, personal navigation device (PND), Personal Information Manager (PIM), Personal Digital Assistant (PDA), laptop, tablet, a wearable computer, smart watch, or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for updating a digital map, the method comprising:
receiving the digital map, wherein the digital map shows a first region and a second region, and wherein the digital map includes a border that separates the first region from the second region;
receiving user trajectory data;
generating portal information based on the received user trajectory data that cross the border between the first and second regions; and
updating the digital map with the portal information.

2. The method of claim 1, wherein generating the portal information includes determining a location of a portal between the first region and the second region based on the received user trajectory data.

3. The method of claim 2, wherein determining the location of the portal includes determining a centroid of a distribution of the received user trajectory data.

4. The method of claim 1, wherein generating the portal information includes determining a size of a portal between the first region and the second region based on the received user trajectory data.

5. The method of claim 4, wherein determining the size of the portal includes determining a standard deviation of a distribution of the received user trajectory data.

6. The method of claim 1, wherein generating the portal information includes determining whether a portal is an entrance or an exit to the first region.

7. The method of claim 6, wherein determining whether the portal is an entrance or an exit to the first region includes:
determining that the portal is an entrance to the first region if the received user trajectory data includes a first percentage of trajectories that cross the border from the second region to the first region; and
determining that the portal is an exit from the first region if the received user trajectory data includes a second percentage of trajectories that cross the border from the first region to the second region.

8. The method of claim 1, wherein the digital map indicates that at least the first region is a region interior to a building, and wherein generating the portal information includes determining that the first region is not a region interior to the building.

9. The method of claim 8, wherein the received user trajectory data includes indoor trajectory data and outdoor trajectory data, the method further comprising determining that the first region is not a region interior to the building if none of the indoor trajectory data align with the first region and if at least one of the outdoor trajectory data align with the first region.

10. A non-transitory computer-readable medium including program code stored thereon for updating a digital map, the program code comprising instructions to:
receive the digital map, wherein the digital map shows a first region and a second region, and wherein the digital map includes a border that separates the first region from the second region;
receive user trajectory data;
generate portal information based on the received user trajectory data that cross the border between the first and second regions; and
update the digital map with the portal information.

11. The computer-readable medium of claim 10, wherein the instructions to generate the portal information includes instructions to determine a location of a portal between the first region and the second region based on the received user trajectory data.

12. The computer-readable medium of claim 10, wherein the instructions to generate the portal information includes instructions to determine a size of a portal between the first region and the second region based on the received user trajectory data.

13. The computer-readable medium of claim 10, wherein the instructions to generate the portal information includes instructions to determine whether a portal is an entrance or an exit to the first region.

14. The computer-readable medium of claim 10, wherein the digital map indicates that at least the first region is a region interior to a building, and wherein the instructions to update the digital map with portal information includes instructions to determine that the first region is not a region interior to the building.

15. An apparatus, comprising:
memory adapted to store program code for updating a digital map; and
a processing unit coupled to the memory and configured to access and execute instructions included in the program code, wherein when the instructions are executed by the processing unit, the processing unit configured to direct the apparatus to:
receive the digital map, wherein the digital map shows a first region and a second region, and wherein the digital map includes a border that separates the first region from the second region;
receive user trajectory data;
generate portal information based on the received user trajectory data that cross the border between the first and second regions; and
update the digital map with the portal information.

16. The apparatus of claim 15, wherein the instructions generate the portal information includes instructions to determine a location of a portal between the first region and the second region based on the received user trajectory data.

17. The apparatus of claim 15, wherein the instructions to generate the portal information includes instructions to determine a size of a portal between the first region and the second region based on the received user trajectory data.

18. The apparatus of claim 15, wherein the instructions to generate the portal information includes instructions to determine whether a portal is an entrance or an exit to the first region.

19. The apparatus of claim 15, wherein the digital map indicates that at least the first region is a region interior to a building, and wherein the instructions to update the digital map with portal information includes instructions to determine that the first region is not a region interior to the building.
